(19) United States
(12) Patent Application Publication
(10) Pub. No.: US 2003/0102266 A1
(43) Pub. Date: Jun. 5, 2003

(54) Process flash chromatography column

(76) Inventor: Robert P. Ritacco, Jamestown, RI (US)

Correspondence Address: Varian Inc, Legal Department, 3120 Hansen Way MS D 102, Palo Alto, CA, 94304, US

(21) Appl. No.: 10/239,275

(22) PCT Filed: Feb. 4, 2002
(86) PCT No.: PCT/US02/03343

(51) Int. Cl. B01D 15/08

(52) U.S. Cl. 210/656; 210/198.2

(57) ABSTRACT

A chromatography column assembly includes a single-ended cartridge containing a sorbent, a column housing for receiving the cartridge, and a compression head for closing the cartridge. The cartridge includes a cartridge housing having an open end and a closed end, an inlet tube extending from the open end to the closed end of the cartridge housing and having a fluid connection to the inlet tube, and a sorbent disposed within the interior volume of the cartridge housing. Filter elements may be disposed at opposite ends of the sorbent. The compression head may include a flow distribution device that provides a fluid connection between the upper end of the cartridge and an outlet.

### CROSS REFERENCE TO RELATED APPLICATION

This application claims the benefit of provisional application Serial No. 60/266,338, filed Feb. 2, 2001, which is hereby incorporated by reference.

### FIELD OF THE INVENTION

This invention leads to chromatographic columns and, or particularly, to process chromtography columns which have a disposable cartridge and thereby limit exposure of the operator to hazardous materials.

### BACKGROUND OF THE INVENTION

Chromatography is a well-known method of separating and analyzing mixtures of chemical substances. A flow of a solvent containing a mixture causes the components of the mixture to migrate differentially in a porous, insoluble chromatographic sorbent. Chromtography facilitates the purification, isolation and comparison of the components of mixtures of chemical substances.

A major component of a chromatography system is a chromatography column. Prior art chromatography columns typically include a tube or housing which contains the chromatographic sorbent, an inlet at one end and an outlet at the opposite end. The sorbent may be packed into the column under pressure. A solvent containing a sample flows through the sorbent and is discharged through the outlet. The column may include flow distribution devices for promoting uniform flow of the solvent through the sorbent. Examples of chromatographic columns are disclosed in U.S. Pat. No. 4,582,608, issued Apr. 15, 1986 to Ritacco, and U.S. Pat. No. 4,737,292, issued Apr. 12, 1988 to Ritacco, et al.

In some applications, chromatography columns are used for purification of samples containing hazardous materials. The hazardous materials remain in the sorbent after the purification process. Prior art columns are typically filled with sorbent and are emptied by the operator after use. The operator is thus exposed to the solvent and the sorbent, as well as sorbent contaminated with potentially toxic chemicals after it has been used in a purification process. Such exposure is, of course, undesirable. The problem is particularly severe in the case of large production size chromatography columns.

Accordingly, it is desirable to provide chromatographic columns which are easy to use and which limit exposure of the operator to hazardous materials.

### SUMMARY OF THE INVENTION

According to a first aspect of the invention, a chromatography column assembly is provided. The chromatography column assembly comprises a single-ended cartridge containing a chromatographic sorbent, the cartridge having an inlet, a column housing for receiving the cartridge, and a compression head for closing the cartridge, the compression head having an outlet.

According to another aspect of the invention, a chromatography cartridge is provided. The chromatography cartridge comprises a cartridge housing having an open end and a closed end, an inlet tube extending from the open end-to the closed end of the cartridge housing, a flow distribution device located at the closed end of the cartridge housing and having a fluid connection to the inlet tube, and a chromatographic sorbent disposed within the interior volume of the cartridge housing.

The cartridge may further comprise first and second filter elements disposed at opposite ends of the chromatographic sorbent. The cartridge housing may have a cylindrical geometry, and the inlet tube may be located at the center of the cartridge housing.

The chromatography column may further comprise one or more inflatable seals between the column housing and the cartridge. A liquid may be disposed between the column housing and the cartridge.

The compression head may include a flow distribution device providing a fluid connection between the open end of the cartridge housing and the outlet. The compression head may further include a seal for sealing the compression head to the cartridge housing and a seal for sealing the compression head to inlet tube.

According to another aspect of the invention, a chromatography method is provided. The chromatography method comprises the steps of providing a cartridge housing containing a chromatographic sorbent, the cartridge housing having a open end and a closed end, causing a flow of a solvent through an inlet tube to the closed end of the cartridge housing, distributing the flow of the solvent from the inlet tube over the closed end of the cartridge housing, and causing a flow of the solvent through the chromatographic sorbent from the closed end to the open end of the cartridge housing. The flow of solvent may be directed from the open end of the cartridge housing to an outlet.

### BRIEF DESCRIPTION OF DRAWINGS

For a better understanding of the present invention, reference is made to the accompanying drawings, which are incorporated herein by reference and in which:

FIG. 1 is a partially exploded cross-sectional diagram of a chromatography column in accordance with an embodiment of the invention.

### DETAILED DESCRIPTION

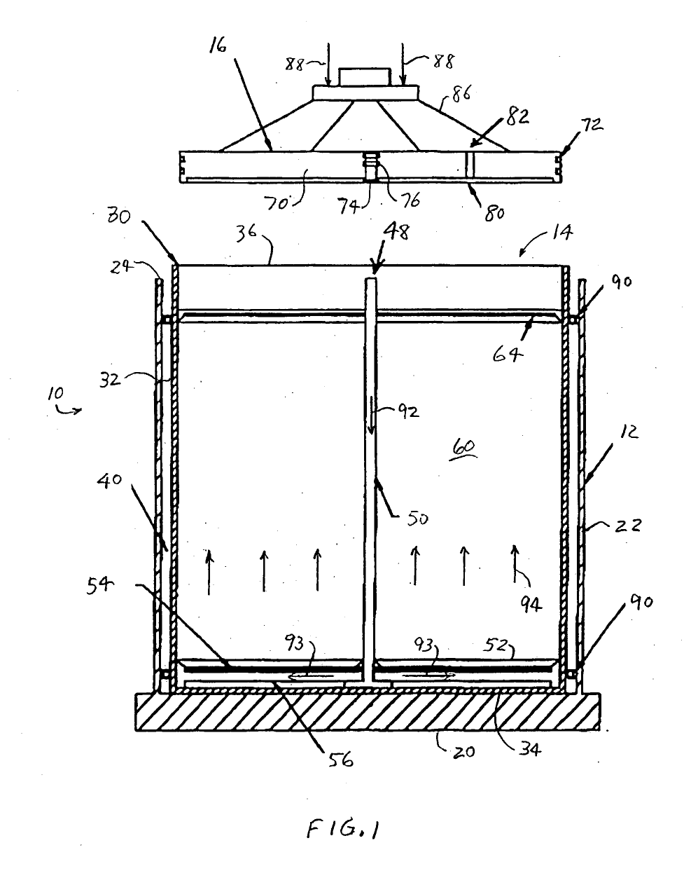

A chromatography column assembly 10 in accordance with an embodiment of the invention is shown in FIG. 1. The chromatography column assembly 10 includes a column housing 12, a cartridge 14 positioned within column housing 12 and a compression head 16. The compression head 16 is shown raised above cartridge 14 to facilitate an understanding of the structure. However, in use, compression head 16 is sealed to the upper end of cartridge 14, as described below. The structure shown in FIG. 1 is particularly suited to large chromatography columns, but is not limited as to size.

The chromatography column preferably has a cylindrical geometry. The column housing 12 includes a relatively thick and rigid base 20 and a cylindrical side wall 22. The column housing 12 may, for example, be fabricated of stainless steel. The column housing 12 has an open upper end 24.

Cartridge 14 includes a cartridge housing 30 having a cylindrical side wall 32, a bottom wall 34 that closes one end of housing 30 and an open upper end 36. Cartridge housing 14 may be fabricated, for example, of stainless steel or ultra high molecular weight polyethylene and is dimensioned to provide a space 40 between side wall 22 of housing 12 and side wall 32 of cartridge housing 30. Thus, each of column housing 12 and cartridge housing 30 is open on only one end and has the shape of a barrel or drum.

A sintered filtered element 52, or frit, and a flow distribution device 54 are positioned at the bottom cartridge housing 30 adjacent to bottom wall 34. An inlet tube 50 extends from just below the open upper end 36 of cartridge housing 30 to the flow distribution device 54. Inlet tube 50 provides an inlet 48 of the cartridge 14. Preferably, inlet tube 50 is centrally located in cartridge housing 30. Filter element 52 is a sintered porous material having a desired porosity. The flow distribution device 54 insures a relatively uniform flow of solvent into the chromatographic sorbent. Filter elements and flow distribution devices for chromatography columns are known in the art, as described, for example, in the aforementioned U.S. Pat. Nos. 4,582,608 and 4,737,292. A support plate 56 may be positioned between bottom wall 34 of cartridge housing 30 and flow distribution device 54. A chromatographic sorbent, such as a silica gel, fills an interior volume 60 of cartridge housing 30 around inlet tube 50. A filter element and holder 64 cover the top of the sorbent with enough space between the filter element and holder 64 and the open end 36 of the cartridge housing 30 to permit the compression head 16 to be installed as described below. Filter element and holder 64 includes a central hole and seal appropriately sized to fit and seal to inlet tube 50.

Compression head 16 is configured to cover upper end 36 of cartridge housing 30 and to compress the sorbent within interior volume 60. Compression head 16 includes a disk-shaped cover 70 having a seal 72 around its outer periphery. Cover 70 is dimensioned to fit within and seal upper end 36 of cartridge housing 30. Cover 70 further includes a central opening 74 for receiving inlet tube 50 and a seal 76 for forming a seal between cover 70 and inlet tube 50. Compression head 16 further includes a flow distribution device 80 mounted to the lower surface of cover 70. The flow distribution device 80 directs solvent flow discharged through filter element and holder 64 to an outlet 82. Compression head 16 further includes a structure 86 for transmitting a compression force, indicated by arrows 88, to cover 70 for compressing the sorbent in interior volume 60.

The cartridge 14 is placed within the column housing 12, and the compression head 16 is positioned within the upper end of cartridge 14 so as to seal the upper end 36 of cartridge housing 30. In particular, a seal is formed between the outer periphery of cover 70 and the inside surface of cartridge housing 30. Also, inlet tube 50 extends through opening 74 and is sealed to cover 70. Inflatable seals 90, located near the top and bottom of column housing 12, are activated, and an appropriate liquid, such as water, is placed in the space between cartridge housing 30 and column housing 12. Since liquids are nearly incompressible, this feature permits the cartridge 14 to be operated without material fatigue.

During operation, a sample to be purified and a solvent are introduced into the column through inlet 48. The sample and the solvent flow downwardly through inlet tube 50, as indicated by arrow 92, to the lower end of cartridge 14. The solvent and sample are distributed over the closed end of cartridge 14 by flow distribution device 54, as indicated by arrows 93, and then flow upwardly through the chromatographic sorbent, as indicated by arrows 94. The solvent passes through filter element and holder 64 and is directed by flow distribution device 80 to outlet 82. When the purification process is complete and the sorbent is spent, the compression head 16 is removed from cartridge 14 and cartridge 14 is removed from column housing 12, is capped and is discarded appropriately. The configuration shown in FIG. 1 and described above permits the chromatography column to operate from one end and limits exposure of the operator to hazardous materials. In addition, the cartridge 14 is disposable as a unit without any need to remove the sorbent from the cartridge housing 30. After a spent cartridge is removed, a new cartridge 14 can be placed in column housing 12.

In one embodiment, the cartridge housing 30 has an inside diameter of 45 centimeters and is 38 centimeters long, thus providing a silica capacity of 35 kilograms for a silica density of 0.6 grams per cubic centimeter. It will be understood that these dimensions are given by way of example only and are not limiting as to the present invention. A variety of different configurations and dimensions may be utilized within the scope of the invention.

It should be understood that various changes and modifications of the embodiments shown in the drawings described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed:

1. A chromatography column assembly comprising:
a single-ended cartridge containing a chromatographic sorbent, said cartridge having an inlet;
a column housing for receiving the cartridge; and
a compression head for closing the cartridge, said compression head having an outlet.

2. A chromatography column assembly as defined in claim 1, wherein said cartridge comprises:
a cartridge housing having an open end and closed end;
an inlet tube extending from the open end to the closed end of said cartridge housing; and
a flow distribution device located at the closed end of said cartridge housing and having a fluid connection to said inlet tube, wherein said chromatographic sorbent is disposed within an interior volume of said cartridge housing.

3. A chromatography column assembly as defined in claim 2, wherein said cartridge further comprises first and second filter elements disposed at opposite ends of said chromatographic sorbent.

4. A chromatography column assembly as defined in claim 1, further comprising one or more inflatable seals between said column housing and said cartridge.

5. A chromatography column assembly as defined in claim 4, further comprising a liquid disposed between said column housing and said cartridge.

6. A chromatography column assembly as defined in claim 2, wherein said compression head further comprises a flow distribution device providing a fluid connection between the open end of said cartridge housing and said outlet.

7. A chromatography column assembly as defined in claim 2, wherein said compression head further comprises a seal for sealing said compression head to said cartridge housing.

8. A chromatography column assembly as defined in claim 2, wherein said compression head further comprises a seal for sealing said compression head to said inlet tube.

9. A chromatography column assembly as defined in claim 2, wherein said flow distribution device is configured for distributing a flow of a solvent from said inlet tube over the closed end of said cartridge housing.

10. A chromatography cartridge comprising:
a cartridge housing having an open end and a closed end;
an inlet tube extending from the open end to the closed end of said cartridge housing;
a flow distribution device located at the closed end of said cartridge housing and having a fluid connection to said inlet tube; and
a chromatographic sorbent disposed within an interior volume of said cartridge housing.

11. A chromatography cartridge as defined in claim 10, further comprising first and second filter elements disposed at opposite ends of said chromatographic sorbent.

12. A chromatography cartridge as defined in claim 11, wherein said cartridge housing comprises stainless steel.

13. A chromatography cartridge as defined in claim 11, wherein said cartridge housing comprises an ultra high molecular weight polyethylene.

14. A chromatography cartridge as defined in claim 11, wherein said cartridge housing has a cylindrical geometry and said inlet tube is located at the center of said cartridge housing.

15. A chromatography cartridge as defined in claim 11, further comprising a support plate located at the closed end of said cartridge housing for supporting said flow distribution device and one of said filter elements.

16. A chromatography cartridge as defined in claim 10, wherein said flow distribution device is configured for distributing a flow of a solvent from said inlet tube over the closed end of said cartridge housing

17. A chromatography method comprising the steps of:
providing a cartridge housing containing a chromatographic sorbent, said cartridge housing having an open end and a closed end;
causing a flow of a solvent through an inlet tube to the closed end of the cartridge housing;
distributing the flow of the solvent from the inlet tube over the closed end of the cartridge housing; and
causing a flow of the solvent through the chromatographic sorbent from the closed end to the open end of the cartridge housing.

18. A method as defined in claim 17, further comprising the step of directing flow of the solvent from the open end of the cartridge housing to an outlet.

19. A method as defined in claim 17 further comprising the step of compressing the chromatographic sorbent.
